(19) United States
(12) Patent Application Publication
(10) Pub. No.: US 2014/0134563 A1
(43) Pub. Date: May 15, 2014

(54) BIOCOMPATIBLE SELF-LIGATING BRACKETS

(71) Applicant: ORTHOARM, INC., TORONTO (CA)

(72) Inventor: John VOUDOURIS, Toronto (CA)

(73) Assignee: ORTHOARM, INC., TORONTO (CA)

(21) Appl. No.: 14/159,082

(22) Filed: Jan. 20, 2014

Related U.S. Application Data
(63) Continuation of application No. PCT/CA2012/050503, filed on Jul. 25, 2012.
(60) Provisional application No. 61/511,315, filed on Jul. 25, 2011.

(51) Int. Cl. A61C 7/28; A61C 7/30

(52) U.S. Cl. CPC A61C 7/287; A61C 7/30
USPC 433/11; 433/13

(57) ABSTRACT

A plurality of self-ligating orthodontic brackets for use in orthodontic treatment comprising at least one first bracket, at least one second bracket, and at least one third bracket. Each of the first, second and third brackets include a first, second and third locking shutter, respectively, for applying a force onto an archwire to effect orthodontic treatment. The first locking shutter applies a first force, the second second locking shutter applies a second force and the third locking shutter applies a third force such that the first, second and third forces differ from each other.

### FIELD OF THE INVENTION

The present invention relates to the field of orthodontic brackets, and more particularly to biocompatible self-ligating brackets.

### BACKGROUND OF THE INVENTION

As is known, orthodontic treatment is effected by fixing small appliances called orthodontic brackets to a patient's teeth. Namely, the orthodontic brackets are most commonly used by being fixed to the patient's teeth in an appropriate manner so as to correct the misaligned teeth by applying an external force thereto through an arch wire extending between the fixed orthodontic brackets. As to the structure of these orthodontic brackets, they are constructed of a body having small slots and are adhered directly on the labial or lingual sides of the teeth or welded to such as metal bands attached to the teeth by cementing or by some other method.

It is well known that the front incisor teeth have single roots that are thin and that these roots are generally more tapered roots susceptible to root resorption or shortening during orthodontic treatment. Often times, when root resorption or shortening is observed in a patient with orthodontics, it is attributed to the magnitude of orthodontic force exerted on the roots by the braces.

In contrast, the middle premolar teeth have larger and thicker roots and the back molars have even larger, and multiple roots that can absorb the generally higher normal orthodontic forces for dental movement than the smaller front teeth. Heretofore, prior art orthodontics, and in particular, prior art self-ligating brackets have been unable to accommodate the varying root sizes and strengths to reduce the risk of root resorption and/or shortening during orthodontic treatment.

### SUMMARY OF THE INVENTION

In accordance with the invention there is provided a set of self-ligating orthodontic brackets that exert progressively lighter forces from the back molars to the front incisor teeth. The invention provides for a number of exemplary embodiments for effecting a set of orthodontic brackets having progressively lighter forces. As will be appreciated by those skilled in the art, the brackets are preferably the same shape and include consistent geometric features to maintain the arch wire between them to provide for the orthodontic treatment of moving the teeth in the front incisor area of the mouth with fewer complications.

It is an object of the invention to provide a set of biocompatible self-ligating orthodontic brackets. It is a further object of the invention to provide a set of orthodontic brackets that are adaptable to exert different forces on different types of teeth to mitigate one or more of the problems with the prior art.

In one embodiment of the invention, there is provided self-ligating orthodontic brackets for use in orthodontic treatment comprising at least one first bracket, at least one second bracket, and at least one third bracket; wherein each of the first, second and third brackets include a first, second and third locking shutter, respectively, for applying a force onto an archwire to effect orthodontic treatment; and wherein the first locking shutter applies a first force, second second locking shutter applies a second force and the third locking shutter applies a third force; wherein the first, second and third forces differ from each other.

According to one aspect of the invention, the first locking shutter has a first thickness, the second locking shutter has a second thickness, and the third locking shutter has a third thickness, wherein the first, second and third thickness are different.

According to another aspect of the invention, the locking shutters are formed from a material selected from the group comprising chromium-cobalt, titanium-molybdenum and nickel-titanium.

According to another aspect of the invention, the first, second and third locking shutters have been subjected to first, second and third heat treatments such that the first locking shutter has a first rigidity, the second locking shutter has a second rigidity and the third locking shutter has a third rigidity, wherein the first, second and third rigidities are different.

According to another aspect of the invention, the first locking shutter comprises nickel-titanium, the second locking shutter comprises titanium-molybdenum, and the third locking shutter comprises chromium-cobalt.

According to another embodiment of the invention, there is provided, there is provided that in a set of self-ligating orthodontic brackets used in orthodontic treatment, wherein each bracket includes a body and a locking shutter for applying a force onto an archwire positioned in an archwire slot within the body, the improvement comprising at least two different locking shutters on at least two different brackets such that the different locking shutters apply different forces to the archwire.

According to third embodiment of the invention, there is provided a kit of self-ligating brackets for use in orthodontic treatment including two or more self-ligating brackets, each self ligating bracket having a body with a bonding base for attachment to the tooth, at least one gingival tie wing and at least one occlusal tie wing, the gingival and occlusal tie wings projecting from a labial surface of the body; an archwire slot extending mesdiodistally across the body and between the gingival and occlusal tie wings; a locking shutter including at least one resilient arm member at one end and a retaining portion at another end, the locking shutter moveable between an open position in which placement and removal of the archwire is facilitated and a closed position in which placement and removal of the archwire is inhibited and a force is applied by the locking shutter on the archwire; wherein at least one bracket in the kit has a locking shutter that applies a different force onto the archwire than a locking shutter of at least one other bracket in the kit.

According to one aspect of the third embodiment, the two or more self-ligating brackets comprises a plurality of self-ligating brackets.

According to another aspect of the third embodiment, the plurality of self-ligating brackets includes at least one first self-ligating bracket with a first locking shutter that applies a first force to the archwire, at least one second self-ligating bracket with a second locking shutter that applies a second force to the archwire, and at least one third self-ligating bracket with a third locking shutter that applies a third force to the archwire; wherein the first, second and third forces are different.

According to another aspect of the third embodiment, the first locking shutter has a first thickness, the second locking shutter has a second thickness, and the third locking shutter has a third thickness, wherein the first, second and third thickness are different.

According to another aspect of the third embodiment, the first thickness is less than or equal to about 0.005 inches, the second thickness is between about greater than 0.005″ inches to 0.006″ inches and the third thickness is greater than or equal to about 0.006″ inches.

According to another aspect of the third embodiment, the locking shutter is formed from a material selected from the group comprising chromium-cobalt, titanium-molybdenum and nickel-titanium.

According to another aspect of the third embodiment, the first, second and third locking shutters have been subjected to first, second and third heat treatments such that the first locking shutter has a first rigidity, the second locking shutter has a second rigidity and the third locking shutter has a third rigidity, wherein the first, second and third rigidities are different.

According to another aspect of the third embodiment, the first, second and third locking shutters have been subjected to first, second and third heat treatments, wherein the first, second and third rigidities are different.

According to another aspect of the third embodiment, the first locking shutter comprises nickel-titanium, the second locking shutter comprises titanium-molybdenum, and the third locking shutter comprises chromium-cobalt.

Other advantages and benefits of the invention will become apparent to a person skilled in the art in view of the detailed description that follows.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIGS. 1A and 1B show a general self-ligating bracket to which the teachings of the invention may be applied.

FIGS. 2A to 2C show one embodiment of the invention in which a set of orthodontic brackets include brackets with different thicknesses of a locking shutter.

FIGS. 3A to 3C show another embodiment of the invention in which a set of orthodontic brackets include brackets with different thicknesses of a locking shutter.

### DETAILED DESCRIPTION

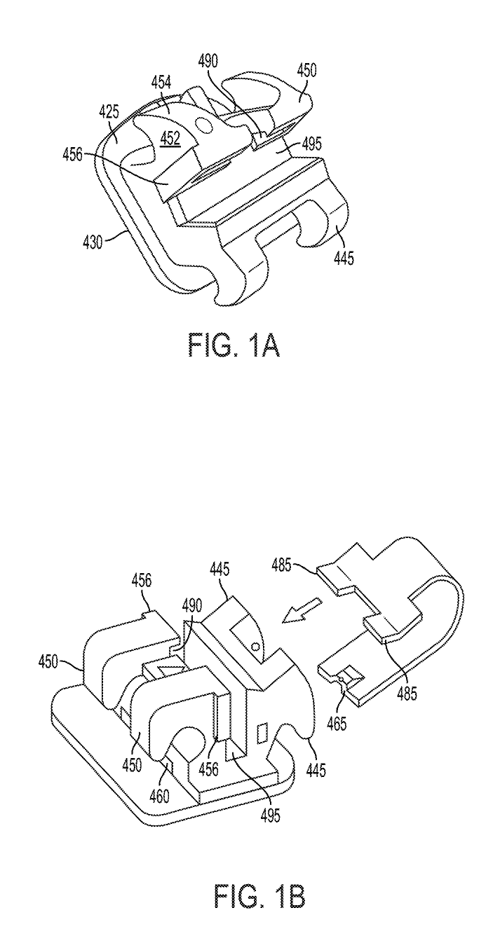

The invention as herein described is applicable to a variety of types of self-ligating orthodontic brackets, and the teachings of the invention will readily be adapted to various implementations of such self-ligating orthodontic brackets. In order to illustrate the invention and show several working examples, various embodiments are described with respect to a typical structure of an orthodontic bracket. With reference to FIG. 1, there is shown a bracket including a body 452 having a bonding base 430 for attachment to a tooth. The base includes a pair of laterally spaced gingival tie wings 450, and a pair of laterally spaced occlusal tie wings 445. The gingival 450 and occlusal tie wings 445 project from a labial surface of the body 452, with the occlusal tie wings 445 defining one or more grooves for receiving one or more arm members 465 of a locking shutter 470 through the occlusal tie wings 445. An archwire slot 495 is provided extending mesiodistally across the body and between the gingival 450 and occlusal 445 tie wings at opposed mesial and distal sides of the body to accommodate an archwire (not shown). The locking shutter 470 is moveable between an open position in which placement and removal of the archwire is facilitated and a closed position in which placement and removal of the archwire is inhibited (as illustrated). In the closed position, a retaining portion 485 of the locking shutter 470 is friction fit into a retaining groove 490 formed adjacent to the archwire slot 495, in each of the gingival tie wings 450. During normal use, when the locking shutter 470 is in the closed position, the archwire is pressed into, and seated entirely within the archwire slot 495.

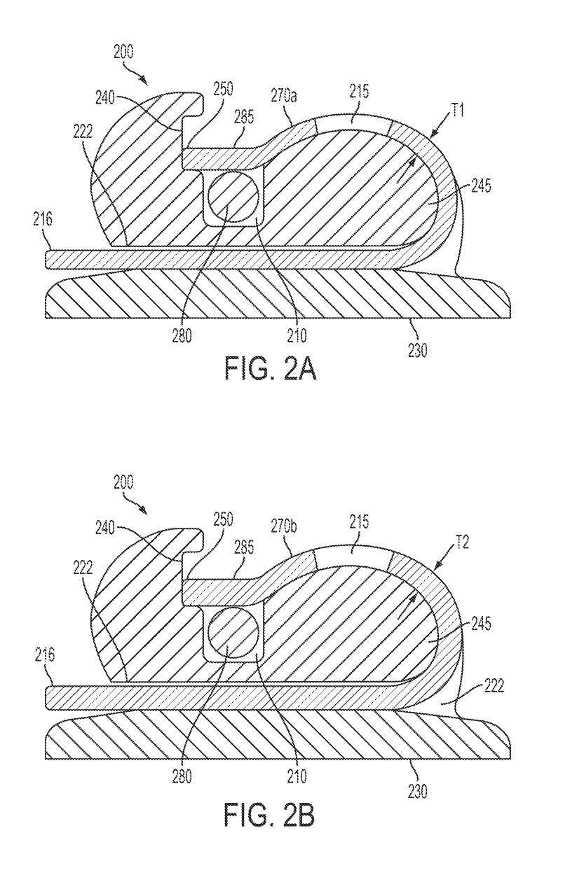

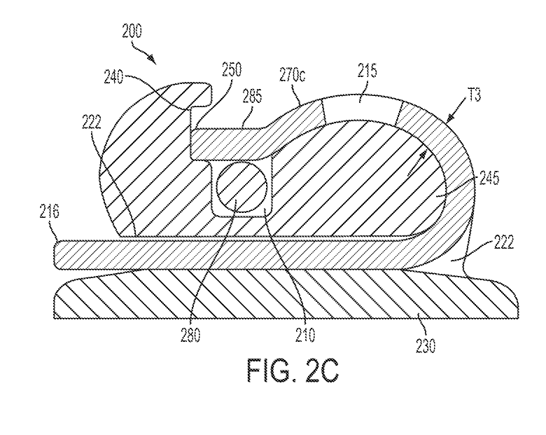

In some embodiments of the invention, the teachings as disclosed herein are also applicable to self-ligating brackets where the locking shutter 470 extends through an opening an opening in the base, and is secured to the bracket by virtue of being fit into this opening. A cross-section of this type of bracket is shown in FIG. 2, for example. In particular, applicant is not limiting the invention to particular arrangements and structures of the body of the bracket as herein described. Rather, the teachings of the invention are applicable to all self-ligating brackets of the type that use a locking shutter to exert a force upon an archwire, as it is in the relationship between the locking shutter and the force being exerted upon the archwire by the locking shutter that the invention particularly pertains to.

The invention provides for a plurality of self-ligating orthodontic brackets, optionally arranged as a set or kit for affecting orthodontic treatment in such a manner so as to provide for progressively lighter forces on the teeth from the back of the mouth towards the front of the mouth, without altering the core design of the orthodontic bracket. That is, the body 25 and all portions of the orthodontic bracket formed unitarily with the body 25 may be made consistent, and preferably, the same body 25 is used to produce each of the plurality of brackets in the set or kit. This provides a two-part benefit over the prior art in that brackets having progressively lighter forces applied to different teeth may be provided within the same set of orthodontic brackets, and further, the body 25 portion of each bracket in the set is the same. This provides a cost effective and efficient way to manufacture, assembly, and apply to a patient each of the brackets within the set. Of course, the invention is not limited to the embodiments in which each of the body portions is the same, but providing a set where this situation is the case provides additional advantages and benefits over the prior art.

Various embodiments of the invention pertain to providing variations on the locking shutter 70 in a manner that the inventor has identified as having a measurable and direct impact on the force each orthodontic bracket applies to a tooth of a patient. Since the locking shutter 70 is generally formed of a spring-type composite material (details on the material are discussed further below), providing a variances in the locking shutter has been found to have an impact on the force applied to the tooth on which a bracket employing the locking shutter is acting. In implementing this discovery, application has provided in one embodiment of the invention, a set of self-ligating orthodontic brackets adapted to exert progressively lighter forces from the back of the mouth towards the front of the mouth. Typically, the forces applied to the molar teeth are higher than those applied to the premolar teeth, which are themselves higher than those applied to the front incisor teeth, for example.

Referring now to FIGS. 2A, 2B and 2C, there are shown a cross-sections of representative self-ligating orthodontic brackets that could be included in the same set or kit according to the invention. The bracket 200 of FIG. 2a includes a locking shutter 270a having a wall thickness T1. The locking shutter 270a is positioned around the occlusal tie wing 245 in a manner known in the art, and is locked in place by virtue of being fit within a groove 222 extending through the body of the bracket 200 beneath the tie wings. On the other side, the locking shutter 270a fits within groove 250 and applies a downwards force onto the archwire 280 positioned within archwire slot 210. The various elements shown in the cross-sectional views are not necessarily drawn to scale in order to graphically depict the invention. The illustrated locking shutter 270a is preferably formed of a resilient stainless steel (or other materials and/or compounds as described in greater detail below) and is pivotally mounted on the occlusal tie wings such that it is moveable between a closed position where access to the archwire slot 210 is inhibited and an open position where access to the archwire slot 210 is permitted. One end of the locking shutter 270a is accommodated in a groove 222 defined in the body of the bracket and having a locking tip 216 preventing accidental movement out of the groove 222. As the shutter 270a translates between open and closed positions, the end 216 of the shutter translates within the groove 222. An aperture 215 is formed in the shutter 270a to accommodate a tool to facilitate opening of the shutter.

The shutter 270a curves labially and gingivally around the occlusal tie wings 245, and then curves lingually towards the archwire slot 210. When the shutter 270a is in the closed position as illustrated, and the archwire 280 applies a labially directed force to the shutter 270a, the gingival end 250 of the shutter 270a contacts the deflection surfaces 240 to inhibit the shutter 270a from being accidentally removed from the archwire slot 210. The operation, including opening and closing of the shutter 270a is generally known in the art and not described herein in further detail. The design of the shutter 270a is such that a rectangular (or circular) archwire is seated to apply torque to the archwire slot 210 depending on the cross-sectional shape of the archwire. The continuous active seating or biasing of the archwire by the locking shutter 270a provides for accurate tooth movement during orthodontic treatment. In view of this, applicant has provided for a set or kit of orthodontic brackets that provide variations in the locking shutter amongst one or more brackets in the kit such that different biasing forces are applied to the archwire depending on the particular locking shutter being used, and accordingly, more accurate tooth movement is provided in a manner that is biocompatible with the particular user, and particular teeth within that user's mouth, over the course of treatment being applied.

The embodiments illustrated in FIGS. 2B and 2C, show representative examples of orthodontic brackets that are provided in the kit of the invention, in which the locking shutters 270b and 270c are provided as having different thickness than the locking shutter 270a of FIG. 2A. Specifically, there is provided a medium-thickness shutter wall 270b in FIG. 2B and a high-thickness shutter wall 270c in FIG. 2C, to be included in the kit that would also include the low-thickness shutter wall 270a. While the terms low-thickness, medium-thickness, and high-thickness are used, they are not to be construed in absolute terms, or vaguely. In particular, these terms are provided to be relative to each other, and applicant expressly defines medium-thickness to be the thickness of a locking shutter that would typically be used in the art. More broadly, and within the scope of the invention, applicant provides for a set of these orthodontic brackets having varying locking shutter thicknesses such that in use, brackets having a relatively thinner shutter wall are used for orthodontic treatment to the front teeth, brackets having a medium-thickness shutter wall are used for orthodontic treatment to the middle teeth, and brackets having a relatively thicker shutter wall are used for the back teeth. This arrangement is unknown in the prior art, which has typically provided the same bracket and locking shutter on all teeth, while relying on a consistent tension throughout the archwire to provide orthodontic treatment by an average force application. Indeed, applicant submits that the invention runs counterintuitive to the historical practice of this type of orthodontic treatment.

In a preferred embodiment, the locking shutter is produce from a metal alloy, such as chromium-cobalt, titanium-molybdenum, or nickel-titanium and the locking shutter wall thickness T1 is in the range of from 0.004″ to 0.005″ for the thin-thickness wall, the thickness T2 is in the range of from 0.005″ to 0.006″ for the medium-thickness wall, and the thickness T3 in the range of from 0.006″ to 0.007″ for the high-thickness wall, for example. While these values have been found to be preferred and of particular benefit during typical treatment, they are not to be considered limiting on the invention. Accordingly, as will be understood by a person skilled in the art, that in varying the thicknesses of the clip portion of the self-ligating brackets in a set or kit of orthodontic treatment brackets, varying forces can be placed on individual teeth to accommodate for different root sizes and thickness and therefore, mitigate the risk of root resorption. Furthermore, the teachings of this embodiment provide for a set of orthodontic brackets that can be manufactured with ease, whereby different brackets are produced from stock material of the same type of material and later being subject to the same heat treatment. That is, no variation in the manufacturing processes are required to manufacture the different brackets in the kits, other than to select a different thickness of stock material from which to begin manufacturing the locking shutter.

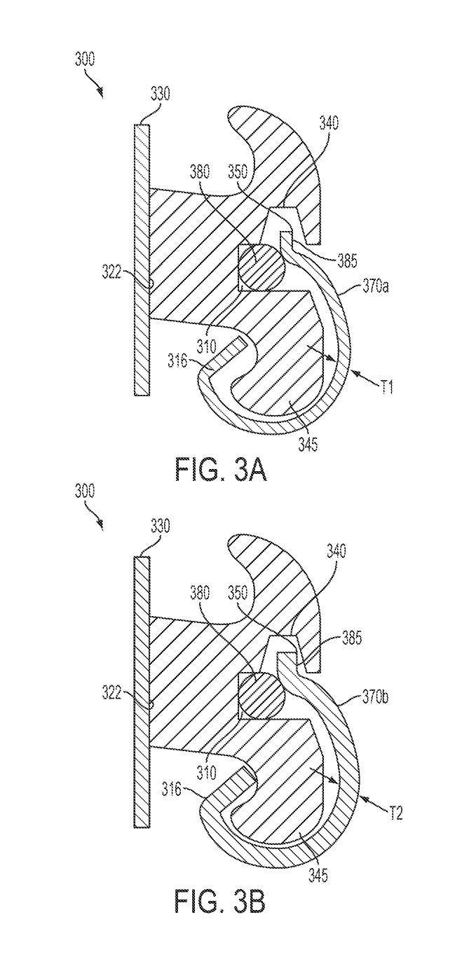

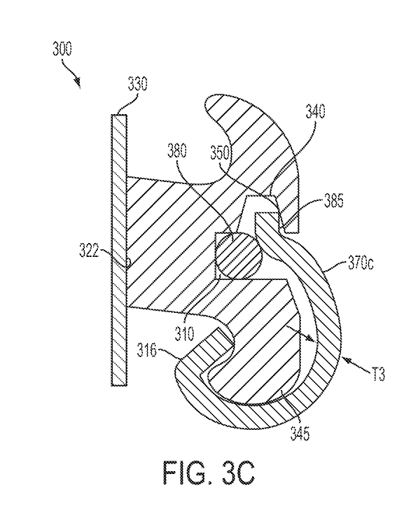

Referring now to FIGS. 3A, 3B and 3C, there is shown another embodiment of the invention, in which the teachings of the invention are applied to the style of orthodontic bracket as shown in FIG. 1. Like elements have been numbered with like numerals, but in the 300 series. In this embodiment, the locking shutter 370 is held in place by having an end portion compression fit in place behind the occlusal tie wings. In any event, the operation of this embodiment is analogous to that as was described with respect to FIGS. 2A, 2B and 2C and accordingly, is not described again in further detail. Applicant has provided FIGS. 3A, 3B and 3C to illustrate that the invention is applicable to different types and styles of self-ligating orthodontic brackets.

According to another embodiment of the invention, the set or kit of self-ligating brackets for orthodontic treatment includes a locking shutter generally as herein described, wherein the locking shutter of each bracket in the set or kit is produced from the same material and from the same thickness of material, but each locking shutter has been subjected to different heat treatments in its manufacturing process to produce varying flexibility in each, or in groups of the locking shutter of the self-ligating brackets within the set or kit. As will be appreciated, by varying the heat treatment applied to the locking shutter during its manufacturing process, the force applied by the locking shutter which has a spring component to it as earlier described, can be made to vary from tooth to tooth. This occurs because when the locking shutter is in its compressed state, its material properties with respect to rigidity of the material results in a different spring properties within the locking shutter and thus lesser and higher forces being applied to the archwire itself. These varying heat treatments renders the set of orthodontic brackets biocompatible as a high degree of customization becomes possible with respect to the forces applied on particular teeth in different areas of the mouth. The heat treatment of spring-steel type materials is well known in the art, and therefore not described herein in more detail. Rather, the application of varying heat treatments to different locking shutters within the same set of brackets results in the improvement over the prior art with respect to this embodiment.

The advantages provided by this embodiment is that each of the brackets in the set or kit are manufactured from the same type and thickness of raw material. In some manufacturing facilities, this is of particular benefit as there is no need to adjust tooling to accommodate a different thickness of material. Adjusting heat treatments to produce varying forces from one bracket to the next within the kit can preferably be accomplished by producing the self-ligating brackets in batches of a particular type, and subsequently assembling, packaging or otherwise arranging same into a set or kit for a particular orthodontic treatment.

According to another embodiment of the invention, the teachings of the two heretofore described embodiments may be combined, such that a combination of different heat treatments and thickness of materials may be used to optimize the flexibility/stiffness of the locking shutter in individual self-ligating brackets used in orthodontic treatment. As will be appreciated by one skilled in the art, a number of self-ligating brackets with the same flexibility may be heat treated as a batch and subsequently assembled, packaged or otherwise arranged into a set or kit for particular orthodontic treatments. Various types of heat treatments are applicable, as would be appreciated by those skilled in the art.

According to another embodiment of the invention, the locking shutter of the self-ligating brackets in a set or kit of same for orthodontic treatment are made from different clip materials depending on which teeth the bracket is intended to be used with. That is, the material of the bracket is varied to produce low, medium and high forces on the front, middle and back teeth respectively. For example, a more flexible alloy such as nickel-titanium (Ni—Ti) may be used for the clip being applied to the front teeth, the more stiffer titanium-molybdenum (Ti—Mb) may be used for the clip being applied to the middle teeth, and the stiffer chromium-cobalt (Cr—Co) may be used for the clip being applied to the back teeth. This variation in materials can produce the different brackets within the set or kit as herein described.

Accordingly, various embodiments of the invention have been described above, that have the effect of a progressive, graduated force being applied on the dentition consistent with the respective root anatomy for more highly effective, efficient and biocompatible tooth movement that reduces the risk for root resorption. The invention is not limited to the embodiments herein described. Rather, variations on the above-described embodiments that produce a kit or set of self-ligating brackets for orthodontic treatments having clips that differ from each other to apply light, medium and normal forces to the front, middle and back teeth, respectively, are also contemplated by the invention. For example, it is also contemplated that each tooth in the mouth has an associated bracket with a locking shutter having a different force applied.

1. Self-ligating orthodontic brackets for use in orthodontic treatment comprising at least one first bracket, at least one second bracket, and at least one third bracket; wherein each of said first, second and third brackets include a first, second and third locking shutter, respectively, for applying a force onto an archwire to effect orthodontic treatment; and wherein said first locking shutter applies a first force, second second locking shutter applies a second force and said third locking shutter applies a third force; wherein said first, second and third forces differ from each other.

2. Self-ligating orthodontic brackets according to claim 1, wherein said first locking shutter has a first thickness, said second locking shutter has a second thickness, and said third locking shutter has a third thickness, wherein said first, second and third thickness are different.

3. Self-ligating orthodontic brackets according to claim 1, wherein said locking shutters are formed from a material selected from the group comprising chromium-cobalt, titanium-molybdenum and nickel-titanium.

4. Self-ligating orthodontic brackets according to claim 1, wherein said first, second and third locking shutters have been subjected to first, second and third heat treatments such that said first locking shutter has a first rigidity, said second locking shutter has a second rigidity and said third locking shutter has a third rigidity, wherein said first, second and third rigidities are different.

5. Self-ligating orthodontic brackets according to claim 1, wherein said first locking shutter comprises nickel-titanium, said second locking shutter comprises titanium-molybdenum, and said third locking shutter comprises chromium-cobalt.

6. In a set of self-ligating orthodontic brackets used in orthodontic treatment, wherein each bracket includes a body and a locking shutter for applying a force onto an archwire positioned in an archwire slot within the body, the improvement comprising at least two different locking shutters on at least two different brackets such that said different locking shutters apply different forces to said archwire.

7. A kit of self-ligating brackets for use in orthodontic treatment comprising
two or more self-ligating brackets, each self ligating bracket having
a body with a bonding base for attachment to the tooth, at least one gingival tie wing and at least one occlusal tie wing, said gingival and occlusal tie wings projecting from a labial surface of said body;
an archwire slot extending mesdiodistally across said body and between the gingival and occlusal tie wings;
a locking shutter including at least one resilient arm member at one end and a retaining portion at another end, said locking shutter moveable between an open position in which placement and removal of said archwire is facilitated and a closed position in which placement and removal of said archwire is inhibited and a force is applied by said locking shutter on said archwire;
wherein at least one bracket in the kit has a locking shutter that applies a different force onto said archwire than a locking shutter of at least one other bracket in the kit.

8. A kit according to claim 7, wherein said two or more self-ligating brackets comprises a plurality of self-ligating brackets.

9. A kit according to claim 8, wherein said plurality of self-ligating brackets includes at least one first self-ligating bracket with a first locking shutter that applies a first force to said archwire, at least one second self-ligating bracket with a second locking shutter that applies a second force to said archwire, and at least one third self-ligating bracket with a third locking shutter that applies a third force to said archwire; wherein said first, second and third forces are different.

10. A kit according to claim to claim 9, wherein said first locking shutter has a first thickness, said second locking shutter has a second thickness, and said third locking shutter has a third thickness, wherein said first, second and third thickness are different.

11. A kit according to claim 10, wherein said first thickness is less than or equal to about 0.005 inches, said second thickness is between about greater than 0.005″ inches to 0.006″ inches and said third thickness is greater than or equal to about 0.006″ inches.

12. A kit according to claim 10, wherein said locking shutter is formed from a material selected from the group comprising chromium-cobalt, titanium-molybdenum and nickel-titanium.

13. A kit according to claim 9, wherein said first, second and third locking shutters have been subjected to first, second and third heat treatments such that said first locking shutter has a first rigidity, said second locking shutter has a second rigidity and said third locking shutter has a third rigidity, wherein said first, second and third rigidities are different.

14. A kit according to claim 10, wherein said first, second and third locking shutters have been subjected to first, second and third heat treatments, wherein said first, second and third rigidities are different.

15. A kit according to claim 9, wherein said first locking shutter comprises nickel-titanium, said second locking shutter comprises titanium-molybdenum, and said third locking shutter comprises chromium-cobalt.
